(19) United States
(12) Patent Application Publication
(10) Pub. No.: US 2019/0017290 A1
(43) Pub. Date: Jan. 17, 2019

(54) Locking trough

(71) Applicant: Planet GDZ AG, Tagelswangen (CH)

(72) Inventor: Andreas DINTHEER, Illnau (CH)

(21) Appl. No.: 16/068,936

(22) PCT Filed: Dec. 13, 2016
(86) PCT No.: PCT/EP2016/080757

§ 371 Date: Sep. 14, 2018

(30) Foreign Application Priority Data
Jan. 11, 2016 (EP) 16150773.6

(51) Int. Cl. E05B 15/02; E05B 17/00; E05B 15/16

(52) U.S. Cl. CPC E05B 15/0205; E05B 2015/1671; E05B 15/1635; E05B 17/0045

(57) ABSTRACT

The invention relates to a locking trough for receiving a locking bolt of a window or a door, which locking trough has a main body (G) for lying on a building part having a recess. The main body (G) has a cover plate (1) having a passage opening (4). An at least partially closed receiving pocket (6) composed of plastic for receiving the locking bolt is fastened to the main body (G). The locking trough according to the invention can be economically produced, is stable, and can be used in low-noise manner.

### TECHNICAL FIELD

The present invention relates to a locking trough, in particular a floor recess plate.

### PRIOR ART

Locking bolts are used in conjunction with the closing of partitions, multileaf doors, windows or the like. These locking bolts can either be operatively connected to the closing mechanism of the door or be actuatable separately therefrom. These locking bolts are lowered in a locking trough, which is embedded in a recess beneath the door leaf or window casement. If the recess is located in the floor, the locking trough is also referred to as a floor recess plate. These locking troughs usually consist of metal, in particular of stainless steel. Since the locking bolts are also usually made of metal, the locking bolt cannot be lowered noiselessly into the locking trough. Even when the door is closed, such rattling noises are often unavoidable.

DE 20 2011 003 296 U1 therefore proposes a locking trough of which the inner receiving surface is provided with a coating for sound-damping purposes. The coating consists, for instance, of silicone. Although this has proved successful in practice, manufacture is relatively costly.

EP 1 564 353 discloses a locking trough having compensating elements in order to alter the position of the receiving opening relative to the cover plate. Individual elements of the locking trough, or the locking trough as a whole, can be made of plastic material.

EP 1 724 418 describes a locking trough which likewise allows variable adjustment of the position of its receiving opening relative to the locking bolt. This is achieved by use of a base plate, which is fastened on the floor, and of a cover plate, which can be fastened on the base plate such that it can be altered in position relative to the base plate.

### DESCRIPTION OF THE INVENTION

An object of the invention is therefore to provide a locking trough which can be manufactured as easily and cost-effectively as possible and nevertheless offers sufficient guidance when the locking catch is being lowered.

The locking trough according to the invention for receiving a locking bolt of a window or of a door has a main body for resting on a part of a building that comprises a recess, wherein the main body has a cover plate having a through-opening. A receiving pocket made of plastic material for receiving the locking bolt is fastened on the main body.

It is preferable, however, for the main body to have a collar at least partially encompassing the through-opening, and the receiving pocket is arranged on this collar. This facilitates manufacture and ensures stable connection.

The receiving pocket can be fitted onto the collar, hooked into it or engaged therein in some other way. It is preferably the case, however, that it is injection molded onto the collar.

The material of the receiving pocket is thus relatively cost-effective. Furthermore, the plastic material damps any possible noise when the locking bolts are being inserted.

The main body preferably consists of metal, in particular of steel. As a result, it is of relatively stable configuration and it provides increased stability for the guidance of the locking bolt in the inlet region of the locking trough.

If, in the event of fire, the locking pocket becomes detached, the locking bolt is still held in the locking trough, in particular if the main body has a downwardly projecting metal collar. This is important in respect of fire doors. It is also the case in the event of fire that the locking bolt can still be pushed out of the locking trough, so that in an emergency, for example in the event of fire, the door can nevertheless be quickly opened. To this end, a taper of approximately 3° is preferably present.

The metallic main body, in addition, is visually more appealing than if it were also made of plastic material. The main body is preferably formed in one piece. In particular, the cover plate and the collar of the main body are formed together in one piece. This minimizes the manufacturing and production costs, optimizes the visual appearance and increases the stability. The main body is preferably deep-drawn.

The receiving pocket is preferably configured to be open only toward the through-opening and has a closed encircling lateral surface and a closed base. That is to say, it forms a container which is accessible only from above through the cover plate and is otherwise closed.

Preferably the main body, and still more preferably the collar, has anchoring elements for strengthening the connection to the receiving pocket. These anchoring elements are advantageous in particular when the receiving pocket is molded on. In this case, the collar can be formed from a relatively thin material, in particular sheet metal.

The anchoring elements can protrude laterally, upward and/or downward from the main body or collar. They are preferably arranged on the circumference of the collar. Very effective anchoring along with, at the same time, cost-effective manufacture is provided by anchoring elements in the form of recesses and/or through-holes.

The material of the receiving pocket preferably fills the anchoring elements, i.e. the plastic material is injected into the through-holes and/or recesses and form a form closure. This increases the stability of the connection between the collar and receiving pocket.

The through-holes and/or recesses are preferably enclosed by the receiving pocket, in order for anchoring to be improved further. The same applies if the anchoring elements are elevations or other formations.

The collar preferably runs all the way round in an uninterrupted manner. It thereby provides a maximized connecting surface area for the receiving pocket and continuous guidance for the locking bolt.

In order to provide for a smooth transition between the receiving pocket and main body, the cover plate preferably has injection-molding surfaces, which project into the through-opening formed by the cover plate. It is preferably the case that at least one injection-molding surface is present. Preferably an upper and a lower injection-molding surface is present. The at least one specific injection-molding surface is preferably located in the transition region between the collar and cover plate of the main body. The receiving pocket is preferably molded on over this at least one injection-molding surface. This improves the stability of the connection between the main body and receiving pocket.

If the upper injection-molding surface is configured in the form of a step in relation to the surface of the main body, and/or is inclined in relation to the same, then the plastic material can be injection molded flush to this surface.

The receiving pocket preferably encloses the collar at least more or less completely, in particular it is molded on over the entire collar. This maximizes the connecting surface area and helps to maximize the stability of the connection.

Preferably the main body, and still more preferably the cover plate, is fastened on the part of a building. This is done preferably directly with the aid of screws or nails. Fastening holes are preferably present for this purpose in the cover plate. In order that the cover plate can be configured to be as thin as possible, yet nevertheless retain the fastening means, such as screws, the fastening holes preferably have countersinks. These have preferably been achieved by deep-drawing. In another, equally preferred embodiment, the cover plate is of plane-parallel configuration on its underside, wherein the fastening holes preferably have a countersink within the thickness of the cover plate.

The cover plate is preferably of substantially plane-parallel configuration. It can thus rest on the floor in as flush a state as possible and does not constitute a tripping hazard in the upward direction.

The through-opening, and thus the receiving pocket, can be arranged centrally or eccentrically in the main body. The eccentric arrangement has the advantage that it makes different installation positions possible, and the position of the receiving pocket can thus be more easily adapted to the position of the locking bolt. The through-opening, and thus the receiving pocket, can be round, elliptical or oval or be of some other shape. If the locking bolt is a flat bar, then they preferably form an elongated ellipse. If the bolt is round in cross section, then the cross sections of the through-opening and receiving pocket are also preferably round.

Further embodiments are defined in the dependent claims.

### BRIEF DESCRIPTION OF THE DRAWINGS

A preferred embodiment of the invention is described below with reference to the drawings, which serve merely for explanatory purposes and should not be interpreted restrictively. In the drawings:

FIG. 1 shows a view from above of a base part of a locking trough according to the invention;

FIG. 2 shows a longitudinal section through the base part according to FIG. 1;

FIG. 3 shows a perspective view from below of the base part according to FIG. 1;

FIG. 4 shows a perspective view from above of the base part according to FIG. 1;

FIG. 5 shows a view from above of the base part of the locking trough according to the invention from FIG. 1, with the receiving pocket molded on;

FIG. 6 shows a longitudinal section through the locking trough according to FIG. 5;

FIG. 7 shows a perspective view from below of the locking trough according to FIG. 5;

FIG. 8 shows a perspective view from above of the locking trough according to FIG. 5; and

FIG. 9 shows a side view of the locking trough according to FIG. 5.

### DESCRIPTION OF PREFERRED EMBODIMENTS

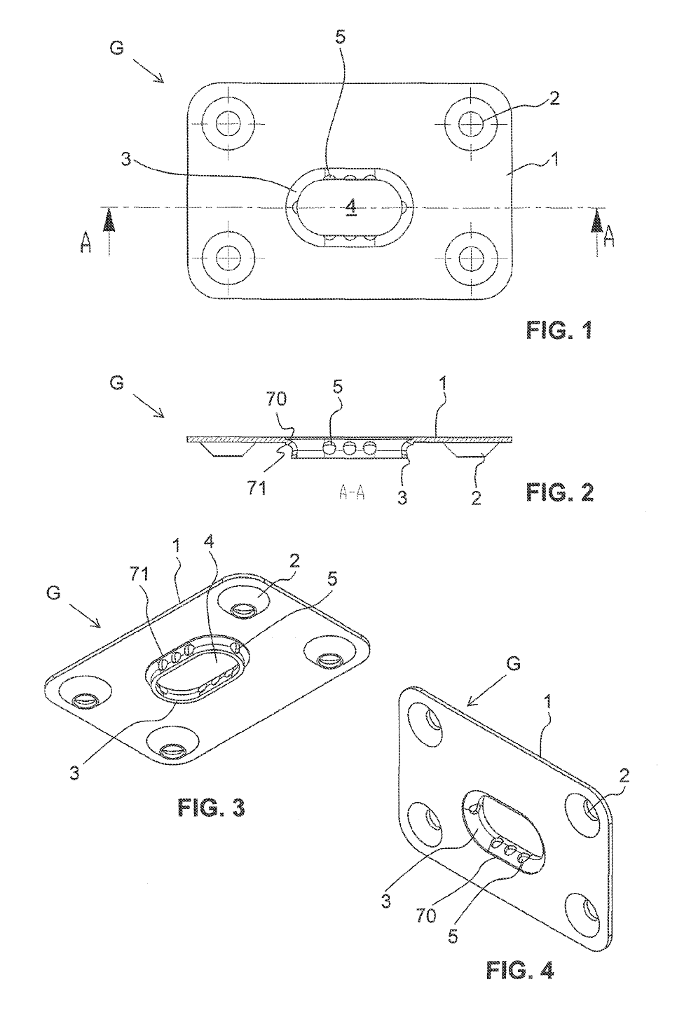

The figures illustrate an exemplary embodiment of a locking trough according to the invention, also referred to as a floor recess plate. FIGS. 1 to 4 show a main body G of this locking trough.

The main body G consists preferably of metal, in particular of steel. It is formed in one piece. It has a cover plate 1, which has a through-opening 4 passing through it. The through-opening 4 is surrounded by a collar 3, which, when installed for use, projects downward. The cover plate 1 has fastening holes 2 passing right through it.

The cover plate 1 is configured to be substantially plane-parallel and as thin as possible. It serves for resting on a part of a building, in particular a floor region beneath a door leaf. It covers over a recess in the part of the building, wherein the through-opening 4 allows access to the recess and the collar 3 is directed toward the recess or even projects into it. The part of the building and the recess are not illustrated in the figures.

The through-opening 4 is arranged preferably eccentrically in the cover plate 1. However, it can also be arranged centrally. In this example, it is configured in the form of an elliptical slot. Other shapes and sizes, however, are also possible. In particular, it can also be of round configuration. Its size and shape are preferably tailored to the size and shape of the locking bolt which is intended to be inserted through it into the recess of the building.

The cover plate 1, and thus the main body G, can be fixed on the part of the building by virtue of the fastening holes 2. Screws are preferably used for this purpose. In order that the fastening holds to a sufficient extent even in the case of a very thin cover plate, the fastening holes in this exemplary embodiment are preferably provided with a countersink, which projects downward in the direction of the part of the building. The underside of the cover plate, however, can also be of plane-parallel configuration, and the fastening holes preferably have a countersink within the thickness of the plate.

In this example, the collar 3 fully encompasses the through-opening 4 and it is of closed configuration. It has anchoring elements, in this case in the form of holes 5. The holes 5 can be merely recesses or pass right through. They are preferably through-holes. In this example, the holes 5 extend along the long and short sides of the through-opening 4, but not in the curved transition regions thereof.

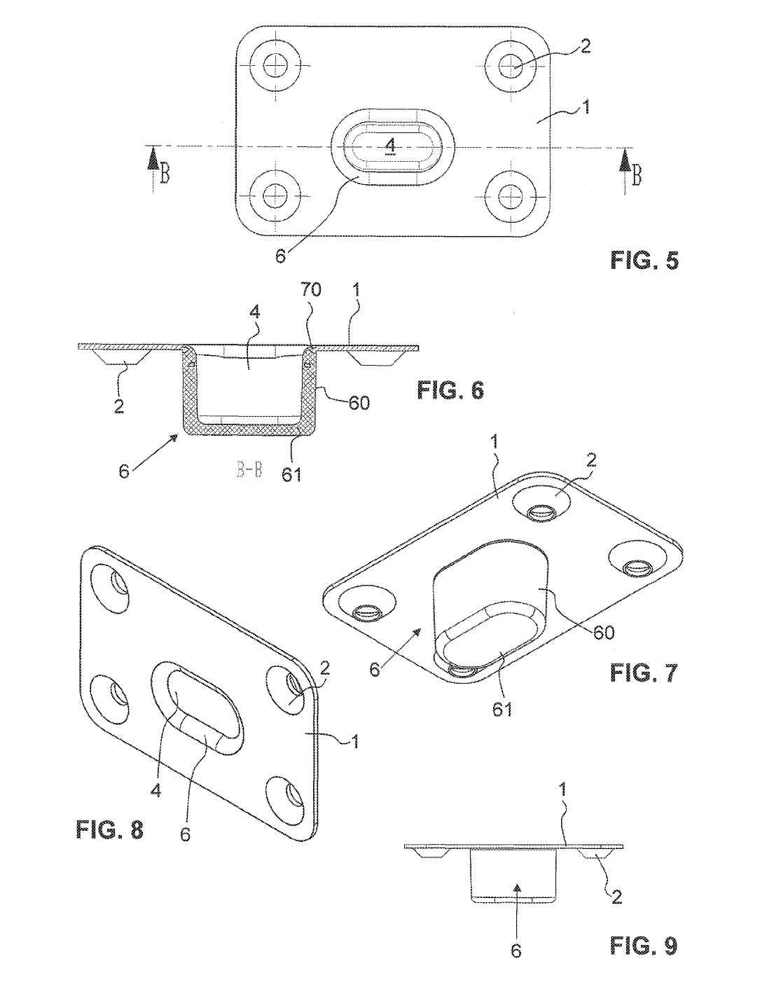

FIGS. 5 to 9 illustrate the complete locking trough according to the invention. It has the above-described main body G as well as a receiving pocket 6 for receiving the lowered locking bolt. The receiving pocket 6 is made of plastic material. It is preferably injection molded onto the collar 3. In this case, it completely encloses the collar 3 and also fills the holes 5.

As can clearly be seen in particular in FIG. 6, the plastic material of the receiving pocket 6 covers over an upper injection-molding surface 70 and a lower injection-molding surface 71. These injection-molding surfaces 70, 71 are formed by the main body G. The upper and/or the lower injection-molding surface 70, 71 are/is preferably inclined in relation to the plane of the cover plate 1. They project preferably into the through-opening 4. These injection-molding surfaces 70, 71 provide for enhanced bonding of the plastic material of the receiving pocket 6 to the main body G. The upper injection-molding surface 70, which is configured in the form of a step relative to the plate surface, provides for a flush transition of the plastic material of the receiving pocket 6 to the material on the upper side of the cover plate 1.

The upper and lower injection-molding surfaces 70, 71 run preferably all the way round the through-opening 4. These two injection-molding surfaces 70, 71 can likewise be manufactured by deep-drawing. They are also clearly discernible in FIGS. 3 and 4.

The shape of the receiving pocket 6 is tailored to the shape of the through-opening 4 or of the collar 3. As in this example, it preferably has a closed encircling lateral surface 60 as well as a downwardly terminating base 61.

The locking trough according to the invention can be manufactured cost-effectively, is stable and can be used with little noise being produced. By virtue of the plastic material being injection molded, it is also possible to manufacture receiving pockets which are smaller, and in particular narrower, than if they are deep-drawn from a metal.

### LIST OF REFERENCE SIGNS

G main body
1 cover plate
2 fastening hole
3 collar
4 through-opening
5 hole
6 receiving pocket
60 lateral surface
61 base
70 upper injection-molding surface
71 lower injection-molding surface

1. A locking trough for receiving a locking bolt of a window or of a door, wherein the locking trough has a main body for resting on a part of a building that comprises a recess, wherein the main body has a cover plate having a through-opening, wherein a plastic material receiving pocket for receiving the locking bolt is fastened on the main body.

2. The locking trough as claimed in claim 1, wherein the main body has a collar at least partially encompassing the through-opening, and wherein the receiving pocket is arranged on this collar.

3. The locking trough as claimed in claim 2, wherein the collar runs all the way round in an uninterrupted manner.

4. The locking trough as claimed in claim 1, wherein the receiving pocket is injection molded onto the main body.

5. The locking trough as claimed in claim 1, wherein the main body consists of metal.

6. The locking trough as claimed in claim 1, wherein the main body is formed in one piece.

7. The locking trough as claimed in claim 1, wherein the receiving pocket is configured to be open only toward the through-opening and has a closed encircling lateral surface and a closed base.

8. The locking trough as claimed in claim 1, wherein the main body has anchoring elements for strengthening the connection to the receiving pocket.

9. The locking trough as claimed in claim 2, wherein the main body has anchoring elements for strengthening the connection to the receiving pocket and wherein these anchoring elements are arranged on the circumference of the collar.

10. The locking trough as claimed in claim 8, wherein the anchoring elements are at least one of recesses and through-holes.

11. The locking trough as claimed in claim 10, wherein the receiving pocket fills the anchoring elements.

12. The locking trough as claimed in claim 8, wherein the receiving pocket encloses the anchoring elements.

13. The locking trough as claimed in claim 1, wherein the main body has a first injection-molding surface, which projects into the through-opening, is of sunken configuration relative to a plate surface of the main body and over which the receiving pocket is molded on.

14. The locking trough as claimed in claim 1, wherein the main body has a second injection-molding surface, which projects into the through-opening, runs on an underside of the main body and over which the receiving pocket is molded on.

15. The locking trough as claimed in claim 1, wherein the receiving pocket is molded on and encloses the collar at least more or less completely.
